(19) United States
(12) Patent Application Publication
(10) Pub. No.: US 2009/0265377 A1
(43) Pub. Date: Oct. 22, 2009

(54) METHOD AND SYSTEM FOR IDENTIFYING A UNIT TO BE TESTED IN A MULTI-ARRAY TEST APPARATUS

(76) Inventors: Theethut Mungronpet, Phitsanulok (TH); Surachai Siriwed, Roi Et Province (TH)

Correspondence Address: HITACHI C/O WAGNER BLECHER LLP, 123 WESTRIDGE DRIVE, WATSONVILLE, CA, 95076, US

(21) Appl. No.: 12/104,272

(22) Filed: Apr. 16, 2008

(51) Int. Cl. G06F 17/30

(52) U.S. Cl. 707/103 R; 707/E17.01

(57) ABSTRACT

A method for identifying a unit to be tested in a multi-array test apparatus comprises uploading into a database an identification of at least one unit to be tested and at least one test protocol associated with the unit. The method further comprises receiving the unit; reading digital information from an identifying label associated with the unit; and comparing the digital information with the identification and the test protocol in the database. Human error is thereby reduced in associating the unit with the test protocol.

### TECHNICAL FIELD

This invention relates generally to the field of identifying and associating a unit with an appropriate test and specifically mitigating human error that can arise in associating a hard disk drive with an appropriate test in a multi-array test apparatus.

### BACKGROUND

Manufacturers of subsystem devices that are assembled into clients' products need to undergo various tests that are approved by the various clients. For example, a General Motors engine plant may make a model of engine that is intended for different applications by their clients; applications such as, a pickup truck, a full-size automobile, and an inboard motor boat. The pickup truck manufacturer, the full-size automobile manufacturer, and the boat manufacturer have their own specific test for the engine that will go into their product even though it may be the same engine model.

Similarly, electronic device manufacturers produce subassemblies that are incorporated into a variety of electronic merchandise whose applications and demands for performance are varied. The tests prescribed for these electronic subassemblies reflect the demands that are placed on the end product in which they will be assembled. An example is the hard disk drive (HDD) which operates in a large variety of computer-based end products. Each producer of computer-based products requires that an HDD pass a test, which is indicative of the HDD performance in their product. Often an HDD manufacturer has several clients who produce computer-based products that use the same model of HDD. Each client has a test protocol that may or may not be the same as another client. The HDD manufacturer needs to accommodate various test protocols for one model of HDD to satisfy their clients test requirements.

### SUMMARY OF THE INVENTION

Various embodiments of the present invention are described herein. A method for identifying a unit to be tested in a multi-array test apparatus comprises uploading into a database an identification of at least one unit to be tested and at least one test protocol associated with the unit. The method further comprises receiving the unit; reading digital information from an identifying label associated with the unit; and comparing the digital information with the identification and the test protocol in the database. Human error is thereby reduced in associating the unit with the test protocol.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a system for identifying a unit to be tested in a multi-array test apparatus in accordance with one embodiment of the present invention.

FIG. 2 is a flow chart illustrating a process for identifying a unit to be tested in a multi-array test apparatus in accordance with one embodiment of the present invention.

### DETAILED DESCRIPTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of embodiments of the present invention, numerous specific details are set forth in order to provide a thorough understanding of the present invention. However, it will be recognized by one of ordinary skill in the art that embodiments of the present invention may be practiced without these specific details. In other instances, well known methods, procedures, and components have not been described in detail as not to unnecessarily obscure aspects of the present invention.

For the sake of brevity and clarity, the discussion will focus on an HDD as an example of a unit to be tested in a multi-array test apparatus that benefits from the embodiments of the present invention. It is understood that embodiments of the present invention are not restricted to the testing of an HDD and may be applied to plethora of units to be tested in a multi-array test apparatus. The discussion will begin with a description and overview of a method for identifying a unit (HDD) to be tested in a multi-array test apparatus. The discussion will then focus on embodiments of the present invention by which identifying a unit (HDD) to be tested in a multi-array test apparatus is implemented.

### Overview

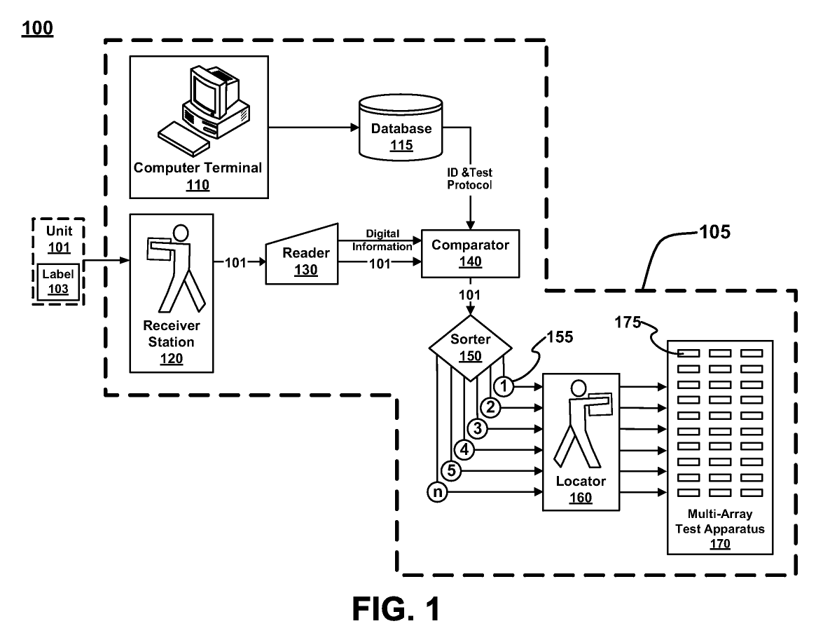

With reference to FIG. 1, block diagram 100 of system 105 is presented in accordance with an embodiment of the present invention. System 105 is a system for identifying a unit, such as an HDD to be tested in a multi-array test apparatus. System 105 reduces human error for associating the HDD with a test protocol.

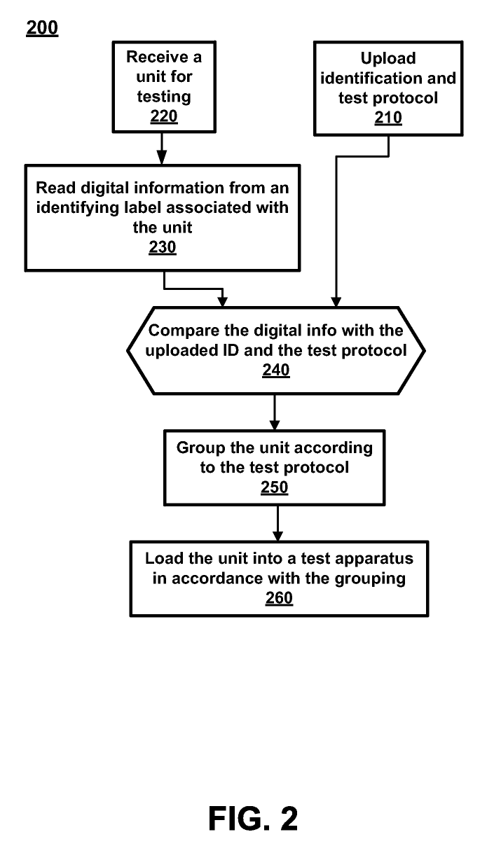

With reference to FIG. 2, a flow chart illustrating a process 200 for identifying a unit to be tested in a multi-array test apparatus is presented in accordance with an embodiment of the present invention. Process 200 presents a method for identifying a unit, for example an HDD, to be tested in a multi-array test apparatus, whereby human error is reduced for associating the HDD with a test protocol.

An HDD is received from a manufacturing process for testing in a multi-array test apparatus. Test engineering provides a test protocol for the HDD that is based upon requirements of the customer for whom the HDD is intended. The multi-array test apparatus can test many HDDs simultaneous with various test protocols assigned to different test bays within the multi-array test apparatus. For a test to be meaningful to a customer the appropriate test protocol should be performed on the appropriate HDD. Current test methods rely upon an operator to manually read the test protocol for the HDD from a spread sheet provided by test engineering. Manually associating the test protocol with the HDD can possibly introduce errors and cause an HDD to be loaded into a test bay which will run a test protocol not associated with the HDD. Errors of this nature consume time and resources and can damage customer confidence in the HDD manufacturer.

### Physical Description

FIG. 1 presents a block diagram 100 of system 105 for identifying a unit to be tested in a multi-array test apparatus in accordance with one embodiment of the present invention. System 105 reduces human error for associating unit 101, e.g. an HDD, with a test protocol by decreasing the reliance on a test operator to manually identify an HDD and manually associate an HDD with the appropriate test protocol.

In accordance with an embodiment of the present invention, system 105 comprises computer terminal 110 whereby an identification of at least one unit 101 to be tested and at least one test protocol associated with unit 101 is uploaded into a database 115. In accordance with one embodiment of the present invention, computer terminal 110 is an input device coupled to a network wherein the network is coupled to database 115. In accordance with another embodiment of the present invention, computer terminal 110 is a dedicated input device coupled only to database 115. Typically a test engineer or personnel acting on behalf of a test engineer, inputs the identification and test protocol into database 115.

In accordance with an embodiment of the present invention, system 105 comprises receiver station 120 whereby unit 101, e.g. an HDD, is received into system 105. Receiver station 120 receives unit 101 from an assembly area wherein mechanical components comprising unit 101 are coupled in a prescribed order and arrangement.

In accordance with an embodiment of the present invention, system 105 comprises reader 130 for reading digital information from an identifying label 103 associated with unit 101. Reader 130 is configured for reading the type of digital information associated with identifying label 103.

In accordance with an embodiment of the present invention, reader 130 is a barcode reader well known in the art. In accordance with an embodiment of the present invention, the barcode associated with unit 101 is part of identifying label 103 coupled with unit 101. In accordance with another embodiment of the present invention, the barcode associated with unit 101 is integral with unit 101, such as a printed or etched barcode on a surface of unit 101. In accordance with another embodiment of the present invention, the barcode associated with unit 101 is coupled with a carrier which holds unit 101 through manufacturing and/or test procedures.

In accordance with another embodiment of the present invention, reader 130 is an RFID (radio frequency identification) reader well known in the art. In accordance with an embodiment of the present invention, identifying label 103 comprises an RFID transponder. In accordance with an embodiment of the present invention, identifying label 103 comprising an RFID transponder is coupled with unit 101. In accordance with another embodiment of the present invention, the RFID transponder associated with unit 101 is coupled with a carrier which holds unit 101 through manufacturing and/or test procedures.

In accordance with an embodiment of the present invention, system 105 comprises comparator 140 for comparing digital information read from label 103 by reader 130 with identification and test protocol uploaded in database 115. Comparator 140 is communicatively coupled with database 115. The comparing of the digital information from label 103 couples a test protocol uploaded and stored in database 115 with unit 101.

In accordance with another embodiment of the present invention, system 105 comprises sorter 150. Sorter 150 is communicatively coupled with comparator 140 and enables unit 101 to be placed in a group 155 which corresponds with a test protocol. The sub-groups “1” through “n” in group 155 correspond to the test protocols which are defined by test engineering and/or a client's requirements. The test protocol coupled with unit 101 is presented to sorter 150 by a communication device such as a display screen, indicator light, and audible signal.

In accordance with another embodiment of the present invention, system 105 comprises locator 160. Locator 160 places unit 101 into a test bay 175 in multi-array test apparatus 170. The placement of unit 101 into test bay 175 is determined by the grouping in group 155 performed by sorter 150. Each test bay 175 in multi-array test apparatus 170 is configured to perform a specific test. Locator 160 places unit 101 into a test bay 175 that will perform the appropriate test. The appropriate test is based upon the digital information read from label 103 by reader 130 and the association of identification and test protocol performed by comparator 140.

### Operation

FIG. 2 is a flow chart illustrating a process 200 for identifying a unit to be tested in a multi-array test apparatus in accordance with one embodiment of the present invention. Process 200 presents a method for identifying a unit, for example an HDD, to be tested in a multi-array test apparatus, whereby human error is reduced for associating the HDD with a test protocol.

In one embodiment, processors and electrical components under the control of computer readable and computer executable instructions carry out process 200. The computer readable and computer executable instructions reside, for example, in data storage features such as computer usable volatile and non-volatile memory. However, the computer readable and computer executable instructions may reside in any type of computer readable medium. Although specific components are disclosed in process 200, such components are examples of components for carrying out process 200. That is, the embodiments of the present invention are well suited to performing various other components or variations of the components recited in FIG. 2. Within the present embodiment, it is appreciated that the components of process 200 may be performed by software, by hardware, by an assembly mechanism, through human interaction, or by any combination of software, hardware, assembly mechanism, and human interaction.

Process 200 will be described with reference to elements shown in FIG. 1.

In one embodiment, as shown at 210 of process 200, identification of at least one unit 101 to be tested and at least one test protocol associated with unit 101 is uploaded into a database 115. Personnel, such as a test engineer loads the identification of unit 101 into a database along with a test protocol that has been specified in accordance with a client's requirements. For example, one model of HDD assembled to one set of specifications, will perform at various duty cycles or under varying operating conditions. One client may use a model of HDD in a server application, while another may use the same model of HDD in an automotive application. A server application can require manipulating large amounts of data quickly and seldom powered down. An automotive application can require powering on and off with the car's starting and stopping, and endure extreme conditions of temperature and vibrations. The test protocol for the server application and the automotive application can be very different for representing the clients' requirements.

In one embodiment, as shown at 220 of process 200, unit 101 is received for testing. It is typical, but not necessary to receive unit 101 directly from a manufacturing area. In accordance with embodiments of the present invention, element 220 is remote from the vicinity of a manufacturing area of unit 101.

In one embodiment as shown at 230 of process 200, digital information is read from an identifying label associated with unit 101, such as label 103. The method of reading digital information is dependent upon the configuration of the identifying label. In accordance with an embodiment of the present invention, reading digital information from the identifying label, such as identifying label 103, comprises scanning with a barcode reader the identifying label, wherein the identifying label comprises a barcode. In one embodiment, the barcode associated with unit 101 is part of identifying label 103 coupled with unit 101. In another embodiment, the barcode associated with unit 101 is integral with unit 101, such as a printed or etched barcode on a surface of unit 101. In another embodiment, the barcode associated with unit 101 is coupled with a carrier which holds unit 101 through manufacturing and/or test procedures.

In accordance with another embodiment of the present invention, reading the information from the identifying label comprises reading with an RFID reader the identifying label, wherein the identifying label comprises an RFID transponder. In accordance with an embodiment of the present invention, an identifying label, such as identifying label 103 comprising an RFID transponder is coupled with unit 101. In accordance with another embodiment of the present invention, the RFID transponder associated with unit 101 is coupled with a carrier which holds unit 101 through manufacturing and/or test procedures.

In one embodiment, as shown at 240 of process 200, the digital information read from the identifying label is compared with the uploaded identification of unit 101 and the test protocol stored in database 115. The comparison couples a test protocol with unit 101.

In another embodiment as shown at 250 of process 200, unit 101 is grouped according to the test protocol coupled to it by the comparison shown at 240. The test protocol coupled with unit 101 is presented by a communication device such as a display screen, indicator light, and audible signal.

In another embodiment as shown at 260 of process 200, unit 101 is loaded into a multi-array test apparatus, such as multi-array test apparatus 170 of system 105 in accordance with the grouping performed at 250 of process 200. A multi-array test apparatus, such as multi-array test apparatus 170 of system 105 comprises test bay 175. Each test bay 175 in multi-array test apparatus 170 is configured to perform a specific test. Unit 101 is loaded into a test bay 175 that will perform the specific test. The specific test is based upon the digital information read from label 103 and the association of identification and test protocol performed at 240 of process 200.

The present invention, in the various presented embodiments, reduces human error that can arise when associating a unit to be tested with a predetermined test protocol. Reduction of human error is accomplished with the various presented embodiments by decreasing the reliance on a test operator to manually identify an HDD and manually associate an HDD with the appropriate test protocol. Embodiments of the present invention provide an efficient and economical means for testing units of the same model and configuration to differing test protocols. By reducing human error, test time is reduced and the efficient use of the tester is improved.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for identifying a unit to be tested comprising:
uploading into a database an identification of at least one said unit to be tested in a multi-array test apparatus, and at least one test protocol associated with said unit;
receiving said unit;
reading digital information from an identifying label associated with said unit; and
comparing said digital information with said identification and said test protocol in said database.

2. The method as recited in claim 1, wherein said unit to be tested comprises a hard disk drive.

3. The method as recited in claim 1, further comprising:
grouping said unit according to said test protocol; and
loading said unit into said multi-array test apparatus in accordance with said grouping.

4. The method as recited in claim 1, wherein said reading said digital information from said identifying label comprising:
scanning with a barcode reader said identifying label, wherein said identifying label comprises a barcode.

5. The method as recited in claim 1, wherein said reading said information from said identifying label comprising:
reading with an RFID reader said identifying label, wherein said identifying label comprises an RFID transponder.

6. The method as recited in claim 1, wherein said identifying label is coupled with said unit.

7. The method as recited in claim 1, wherein said identifying label is coupled with a carrier holding said unit.

8. A system for identifying a unit to be tested comprising:
a computer terminal for uploading into a database an identification of at least one said unit to be tested in a multi-array test apparatus, and at least one test protocol associated with said unit;
a receiver station for receiving said unit;
a reader for reading digital information from an identifying label associated with said unit; and
a comparator for comparing said digital information with said identification and said test protocol in said database, thereby reducing human error in associating said unit with said test protocol.

9. The system as recited in claim 8, wherein said unit to be tested comprises a hard disk drive.

10. The system as recited in claim 8, further comprises:
a sorter for grouping said unit according to said test protocol; and
a locator for placing said unit into said multi-array test apparatus in accordance with said grouping.

11. The system as recited in claim 8, wherein said reader comprises:
a barcode reader for scanning said identifying label, wherein said identifying label comprises a barcode.

12. The system as recited in claim 8, wherein said reader comprises:
an RFID reader for reading said identifying label, wherein said identifying label comprises an RFID transponder.

13. The system as recited in claim 8, wherein said identifying label is coupled with said unit.

14. The system as recited in claim 8, wherein said identifying label is coupled with a carrier holding said unit.

15. A computer-readable memory containing executable instructions, wherein said instructions when executed effect a method for identifying a unit to be tested comprising:
uploading into a database an identification of at least one said unit to be tested in a multi-array test apparatus, and at least one test protocol associated with said unit;
receiving said unit;
reading digital information from an identifying label associated with said unit; and
comparing said digital information with said identification and said test protocol in said database.

16. The computer-readable memory as described in claim 15, wherein said unit to be tested comprises a hard disk drive.

17. The computer-readable memory as described in claim 15, further comprising:
grouping said unit according to said test protocol; and
loading said unit into said multi-array test apparatus in accordance with said grouping.

18. The computer-readable memory as described in claim 15, wherein said reading said digital information from said identifying label comprising:
scanning with a barcode reader said identifying label, wherein said identifying label comprises a barcode.

19. The computer-readable memory as described in claim 15, wherein said reading said information from said identifying label comprising:
reading with an RFID reader said identifying label, wherein said identifying label comprises an RFID transponder.

20. The computer-readable memory as described in claim 15, wherein said identifying label is coupled with said unit.

21. The computer-readable memory as described in claim 15, wherein said identifying label is coupled with a carrier holding said unit.
